(19) United States
(12) Patent Application Publication
(10) Pub. No.: US 2006/0280891 A1
(43) Pub. Date: Dec. 14, 2006

(54) Edge protector with self adhesive and release liner

(76) Inventor: Robert W. Swannell, Neenah, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/150,674

(22) Filed: Jun. 10, 2005

(51) Int. Cl. B32B 33/00

(52) U.S. Cl. 428/40.1; 428/194

(57) ABSTRACT

An elongated edge protector for protecting an edge or corner of an article. The edge protector includes an adhesive strip applied to only one leg of the main body such that the edge protector can be self-supported along a corner of an article being protected. The pressure-sensitive adhesive is positioned along only one of the first and second legs and includes a release liner adhered to the adhesive strip. The release liner has a width greater than the width of the pressure-sensitive adhesive to define a grasping tab. The adhesive strip can be either a permanent adhesive or a releasable adhesive sufficient to support the edge protector along the article being protected.

### BACKGROUND OF THE INVENTION

The present invention generally relates to elongated edge protectors for protecting an edge or corner of an item being shipped or transported. More specifically, the present invention relates to an elongated edge protector having an adhesive strip formed along only one leg of the edge protector to permit attachment of the edge protector to the item being shipped or transported.

Packages, articles, products, palletized loads and the like are often subject to damage during shipping or transit. The traditional method of shipping a product, such as a large appliance, involves packaging the product within a cardboard box having cardboard inserts for positioning and holding the product within the box. After each product is packaged within a box, multiple boxes are assembled into an orderly stack onto a pallet or shipping crate. Once the products are assembled onto the pallet, the stack of products are typically wrapped in a heat shrinkable plastic sheet to maintain the integrity of the assembled stack.

During shipment and storage, the corner edges of each box may become damaged. Thus, before the assembled stack is wrapped with the heat shrink plastic material, edge protectors are often used along the outside corners of the assembled stack. Edge or corner protectors are typically formed from one or more pieces of paperboard, cardboard and/or corrugated cardboard folded into a rigid V-shape member having a pair of transversely oriented leg members joined at a generally curved apex.

Although the edge protectors can be manually held in place as the heat shrinkable plastic sheet is wrapped around the assembled stack, it is desirable to provide an edge protector that is self-adhering to facilitate the packaging process. Although a self-adhering edge protector is desirable, the edge protectors must also be stackable for storage prior to use.

Presently, edge protectors are available that include an adhesive material positioned on both legs of the edge protector. When the edge protector is to be used, both legs of the edge protector are attached to the assembled stack of products.

Although such a self-adhering edge protector can be utilized in packaging systems, most edge protectors do not define a true right angle between the transversely extending legs. Thus, when the edge protector is applied to the corner of a product package, the transverse legs of the edge protector often cannot both be simultaneously adhered to the stacked products.

Therefore, it is desirable to provide an edge protector that can be stored and stacked and includes an adhesive strip along only one leg of the edge protector for attaching the edge protector to an article. It is desirable to provide such an edge protector that increases the ease of use while providing adequate strength and product protection.

### SUMMARY OF THE INVENTION

The present invention is an edge protector for protecting an edge or corner of an article. The edge protector includes an adhesive strip such that the edge protector can be self-supported along the article being protected.

The edge protector includes a main body having a generally right angle cross-section that is defined by a first leg and a second leg joined to each other along an apex. Generally, the apex defines a right angle between the first and second legs of the main body. Each of the first and second legs includes both an inside face surface and an outside face surface. The main body extends from a first end to a second end.

A pressure-sensitive adhesive strip is positioned along only one of the first and second legs of the main body. The adhesive strip has a width defined by a first edge and a second edge. The pressure-sensitive adhesive strip may be applied to either the outer face surface or the inner face surface of either the first or second leg of the main body. The pressure-sensitive adhesive strip allows the edge protector to be self-supported along an edge or corner of the article being protected.

The edge protector includes a release liner that is removably attached to the adhesive strip to protect the adhesive strip prior to application of the edge protector to the product being protected. The release liner has a width that is greater than or equal to the width of the pressure-sensitive adhesive strip such that the release liner completely covers the pressure-sensitive adhesive strip prior to removal of the release liner from the pressure-sensitive adhesive strip. In one embodiment of the invention, the release liner extends past the adhesive strip to define a grasping tab. The grasping tab can be used by a user to grasp the release liner and remove the release liner from the pressure-sensitive adhesive strip before application of the edge protector to the product being protected.

The adhesive strip can be applied to either the inner face surface or the outer face surface of either leg of the main body. The use of the adhesive strip along the inner face surface of the body allows the edge protector to be applied to an exterior corner of a product, while use of the adhesive strip along the outer face surface of the main body allows the edge protector to be applied to an inner corner of a product package.

In one embodiment of the invention, the main body of the edge protector is formed from a plurality of layers of paperboard plies each laminated together. However, it is contemplated that the edge protector could also be formed from other materials, such as plastic.

### BRIEF DESCRIPTION OF THE DRAWINGS

The drawings illustrate the best mode presently contemplated from carrying out the invention in drawings.

FIG. 1 is a perspective view of an assembled stack of articles including a packaging system utilizing the edge protector of the present invention;

FIG. 2 is a front perspective view of the edge protector with the release liner being partially removed;

FIG. 3 is a section view taken along line 3-3 of FIG. 2;

FIG. 4 is a magnified view of the adhesive strip and release liner taken along line 4-4 of FIG. 3;

FIG. 5 is a perspective view illustrating the use of the edge protector along an inside corner of a product package; and

FIG. 6 is a perspective view of the edge protector including the adhesive strip and release liner along an outer face surface of one of the product legs.

### DETAILED DESCRIPTION OF THE INVENTION

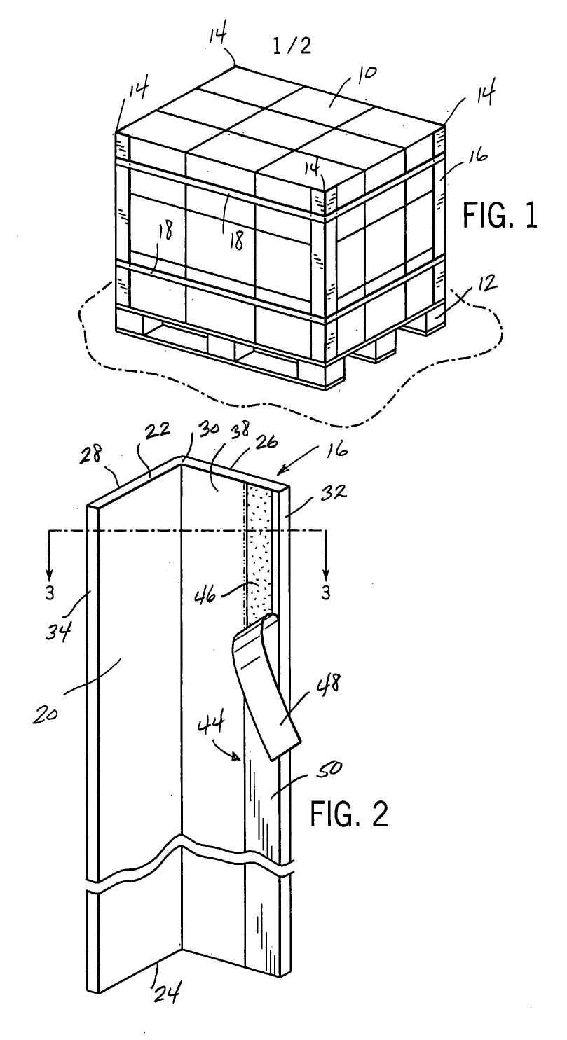

Referring first to FIG. 1, a plurality of individual articles 10 are shown stacked on a pallet 12 for storing or shipment. In the embodiment shown in FIG. 1, the articles 10 are each represented by cardboard boxes, each of which may include a product being shipped by a manufacturer or retailer. The stack of articles define outer corners 14 that are exposed and can be damaged during storage and shipment. To protect the corner articles, a packaging system including multiple edge protectors 16 and retaining straps 18 can be used. The edge protectors 16 are positioned along the outer corners 14 of the assembled stack of articles 10 and protect the corners of each article 10 from damage during shipment and from the pressure exerted by the retaining straps 18. The retaining straps 18 could be replaced by a shrink wrap plastic material.

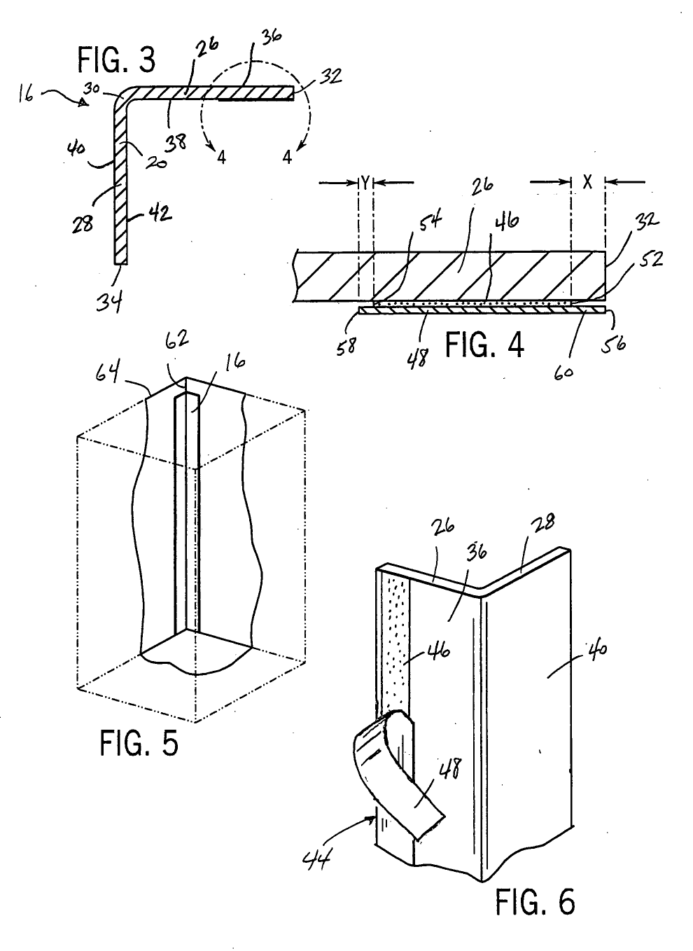

Referring to FIGS. 2 and 3, the edge protector 16 includes a main body 20 extending between a first end 22 and a second end 24. The main body 20 has a generally 90° right angle cross-section formed by a first leg 28 and a second leg 26 joined to each other along an apex 30. The first leg 26 extends from the apex 30 to an outer edge 32 while the second leg 28 extends from the apex 30 to outer edge 34.

The main body 24, including the first and second legs 26, 28 is preferably formed from a plurality of paperboard plies laminated together and formed into the generally V-shaped right angle configuration shown in FIGS. 2 and 3. The manufacture and creation of a right angle edge protector is well known in the industry.

As to be understood in FIG. 3, the angle between the first leg 26 and the second leg 28 is preferably close to 90°. However, due to the manufacturing process used to form the main body 20, the angle defined by the apex 30 may be slightly greater than or slightly less than the desired 90°.

As can be seen in FIG. 3, the first leg 26 includes an outer face surface 36 and an inner face surface 38. Likewise, the second leg 28 also includes an outer face surface 40 and an inner face surface 42. The outer face surfaces 36, 40 of the edge protector 16 can be formed from either a strip of paperboard material or can include a clay-coated paper label. The use of a paper label along the outer face surfaces 36, 40 allows graphics to be printed along the outer face surfaces 36, 38 as is well known.

Referring back to FIG. 2, the first leg 26 includes a length of adhesive tape 44 attached to the inner face surface 38. The adhesive tape 44 includes a pressure-sensitive adhesive strip 46 and a removable release liner 48. The adhesive tape 44 is typically supplied on a continuous roll and is applied to the inner face surface 38 during the manufacture of the edge protector 16. The continuous roll of the adhesive tape 44 is created such that the adhesive strip 46 is applied to the top surface 50 of the release liner 48 such that the adhesive tape 44 can be unwound and applied to the edge protector 16.

As illustrated in FIG. 2, once the adhesive tape 44 has been applied to the inner face surface 38, the release liner 48 can be removed to expose the adhesive strip 46. The adhesive strip 46 allows the edge protector 16 to be attached to one of the outer corners 14 of the assembled stack of articles 10, as illustrated in FIG. 1. Since the edge protector 16 is held in place along the assembled stack of articles, the four edge protectors 16 shown in FIG. 1 can be applied to each of the corners 14 and do not need to be held in place while the retaining straps 18 or plastic wrapping material is applied to the entire stack of articles on the pallet 12.

As can be understood in FIGS. 2 and 3, the adhesive tape 44 is applied only to the first leg 26 of the edge protector 16 and is not applied to the second leg 28. The use of the adhesive tape 44 along only one leg of the edge protector 16 is sufficient to hold the edge protector 16 along the assembled stack of articles. Additionally, since the angle between the first leg 26 and the second leg 28 defined by the apex 30 may be greater than or less than an optimal 90°, the use of the adhesive tape 44 along only one of the two legs 26, 28 aids in applying the edge protector 16 to the corner of the assembled stack shown in FIG. 1. If the adhesive tape 44 were applied to both of the legs 26, 28 and the apex 30 created an angle slightly greater than 90°, the two sections of adhesive tape would not be able to be attached to each side of the corner 14 of the assembled stack of articles. Therefore, the use of only a single adhesive strip 46 along only one of the first and second legs 26, 28 allows the edge protector 16 to be adhered to the corner of an assembled stack of articles and decreases the overall cost of producing the edge protector 16.

Referring now to FIG. 4, the adhesive strip 46 includes a width defined by a first edge 52 and a second edge 54. The first edge 52 is positioned generally adjacent to the outer edge 32 of the first leg 26.

The adhesive strip 46 is covered by the release liner 48 as illustrated in FIG. 4. The release liner 48 has a width extending between a first edge 56 and a second edge 58. As illustrated in FIG. 4, the width of the release liner 48 is greater than the width of the adhesive strip 46 such that the first and second edges 56, 58 of the release liner extend past the first and second edges 52, 54 of the adhesive strip 46.

In the embodiment shown in FIG. 4, the first edge 56 of the release liner 48 extends past the first edge 52 of the adhesive strip by a distance X, while the second edge 58 of the release liner 48 extends past the second edge 54 of the adhesive strip by a second distance Y. In the embodiment of the invention illustrated, the distance X is greater than the distance Y. In one contemplated embodiment of the invention, the distance X is ¼″ and the distance Y is ⅛″. The release liner 48 defines a grasping tab 60 having a width of X. The edge of the grasping tab 60, which is defined by the first edge 56, is positioned generally in alignment with the outer edge 32 of the first leg 26. The grasping tab 60 provides an increased area of the release liner 48 that is not attached to the adhesive strip, which aids in permitting the removal of the release liner 48. Although the distances X and Y are shown and described as being different, it is contemplated that the release liner 48 could extend an equal distance from each of the edges 52, 54 of the adhesive strip 46.

The adhesive strip 46 of the adhesive tape 44 can be either a permanent adhesive or a releasable adhesive. If the edge protector 16 is to be applied to a sturdy article and a more aggressive adhesive is needed, the adhesive strip 46 can be a permanent adhesive. However, if the edge protector 16 is to be applied to an article that can be easily damaged, a releasable adhesive can be used so as to not damage the article when the edge protector 16 is removed. In each case, the adhesive strip 46 must be strong enough to hold the edge protector 16 in place prior to application of the retaining straps 18.

In the embodiment of the invention illustrated in FIG. 2, the adhesive tape 44 extends from the first end 22 to the second end 24 of the main body 20. However, it is contemplated that the length of the adhesive tape 44 could be less than the entire length from the first end 22 to the second end 24. The length of the adhesive tape 44 must be sufficient to support the weight of the edge protector 16. Thus, the strength of the adhesive used in the adhesive strip 46 and the length of the main body 20 dictate the length of the adhesive tape 44 required.

Referring now to FIGS. 5 and 6, thereshown is an alternate embodiment of the edge protector 16. In the edge protector 16 shown in FIG. 6, the adhesive tape 44 is applied to the outer surface 36 of the first leg 26. The adhesive tape 44 includes both the release liner 48 and the adhesive strip 46. However, in the embodiment shown in FIGS. 5 and 6, the adhesive tape 44 is applied to the outer surface 36 of the first leg 26 rather than the inner surface 38 as shown in FIG. 2.

As illustrated in FIG. 5, the edge protector 16 can be applied to an inside corner 62 of a storage container 64 by utilizing the adhesive tape 44 on the outer surface 36. The use of the edge protector 16 along the inside corner 62 strengthens the storage container 64 while providing additional protection from the product.

Various alternatives and embodiments are contemplated as being within the scope of the following claims particularly pointing out and distinctly claiming the subject matter regarded as the invention.

What is claimed is:

1. An elongated edge protector for protecting an edge or corner of an article, the edge protector comprising:
a main body having a generally right angle cross-section defined by first leg and a second leg joined at an apex, each of the first and second legs having an inner face and an outer face, the main body extending from a first end to a second end;
a pressure-sensitive adhesive strip positioned along only one of the first and second legs, the adhesive strip having a first width defined by a first edge and a second edge; and
the release liner removably adhered to the adhesive strip, the release liner having a second width greater than or equal to the first width.

2. The edge protector of claim 1 wherein a portion of the release liner extends past the adhesive strip to define a grasping tab.

3. The edge protector of claim 1 wherein the adhesive strip extends from the first end to the second end of the main body.

4. The edge protector of claim 1 wherein the adhesive strip is positioned along the inner face of one of the first and second legs of the main body.

5. The edge protector of claim 1 wherein the body is formed from a plurality of layers of paperboard plies laminated together.

6. The edge protector of claim 1 wherein both the first leg and the second leg extend from the apex to an outer edge, wherein the adhesive strip is positioned adjacent to the outer edge of one of the first and second legs.

7. The edge protector of claim 1 wherein the adhesive strip is positioned along the outer face of one of the first and second legs of the main body.

8. The edge protector of claim 1 wherein the release liner extends past the first edge of the adhesive strip a first distance and extends past the second edge of the adhesive strip a second distance, wherein the first distance is greater than the second distance.

9. The edge protector of claim 8 wherein a portion of the release liner extending past the first edge of the adhesive strip defines a grasping tab.

10. The edge protector of claim 1 wherein the adhesive strip includes a permanent adhesive.

11. The edge protector of claim 1 wherein the adhesive strip includes a releasable adhesive.

12. An elongated edge protector for protecting an edge or corner of an article, the edge protector comprising:
a main body having a generally right angle cross-section defined by a first leg and a second leg joined at an apex, each of the legs having an inner face, an outer face and an outer edge, the main body extending from a first end to a second end;
a pressure-sensitive adhesive strip positioned adjacent to the outer edge of one of the first and second legs, the adhesive strip having a first width defined by a first edge and a second edge; and
a release liner removably adhered to the adhesive strip, the release liner having a second width greater than the first width such that a portion of the release liner extends past the first edge of the adhesive strip to define a grasping tab.

13. The edge protector of claim 12 wherein the adhesive strip is positioned along the inner face of one the first and second legs of the main body.

14. The edge protector of claim 13 wherein the main body is formed from a plurality of layers of paperboard plies laminated together.

15. The edge protector of claim 12 wherein the release liner extends past the first edge of the adhesive strip a first distance and extends past the second edge of the adhesive strip a second distance, wherein the first distance is greater than the second distance and defines the grasping tab.

16. The edge protector of claim 12 wherein the adhesive strip includes a permanent adhesive.

17. The edge protector of claim 12 wherein the adhesive strip includes a releasable adhesive.

18. The edge protector of claim 12 wherein the adhesive strip is positioned along the outer face of one of the first and second legs of the main body.
